(19) United States
(12) Patent Application Publication
(10) Pub. No.: US 2005/0135814 A1
(43) Pub. Date: Jun. 23, 2005

(54) Apparatus and method for simulating a length of optical fiber

(76) Inventor: Stephen Courtney, Ottawa (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 10/736,554

(22) Filed: Dec. 17, 2003

(51) Int. Cl. H04B 10/12

(52) U.S. Cl. 398/147

(57) ABSTRACT

A novel optical network simulation apparatus is disclosed for simulating a fiber optic link of a fiber optic network. In a first embodiment, an optical attenuator and two variable chromatic dispersion devices are used for imparting an attenuation and positive and negative chromatic dispersion, respectively, for an optical signal propagating from an input port to an output port of the optical network simulation apparatus. In a second embodiment, a polarization mode dispersion optical device is disposed between the input port to an output port of the optical network simulation apparatus in order to additionally provide polarization mode dispersion to the optical signal propagating from the input port to the output port of the optical network simulation apparatus. A microcontroller is used to control the components within the optical network simulation apparatus in order to perform the simulation for a plurality of different wavelengths.

### FIELD OF THE INVENTION

The invention relates to the field of testing of optical systems that incorporate substantial lengths of optical fiber and more specifically to the field of devices and methods for simulating a length of fiber of optical along with variable optical properties associated therewith.

### BACKGROUND OF THE INVENTION

Coarse Wavelength Division Multiplexing (CWDM) and Dense Wavelength Division Multiplexing (DWDM) are recent developments of classic WDM (Wavelength Division Multiplexing) systems that allow for increased optical data carrying capacity for a single mode fiber. DWDM systems support a very densely packed series of optical signals in which each optical signal has a characteristicspectral width.. The optical signals corresponding to conventional CWDM systems use a few widely spaced wavelength bands. For both CWDM and DWDM, this requires the development of wavelength multiplexers, with laser sources tuned to specific ITU channel wavelengths, in which wavelength channels are typically spaced at either 100 GHz or 50 Ghz. Of course, other wavelength channel spacings of 12.5 GHz, 25 GHz, 50 GHz, 100 GHz and 200 GHz are also attainable.

High bit rate optical networks like 10 Gb/sec and the emerging 40 Gb/sec require precise tolerance optical components and systems that are able to accommodate optical effects of the fibers, such as attenuation and chromatic dispersion, and physical impairments such as splices and connectors. As the data rate increases above 2.5 Gb/second, the effects of attenuation, chromatic dispersion, especially for DWDM channels, and degraded Bit Error Rate, as optical pulses merge and create Inter-Symbol Interference (ISI), become more problematic.

The need for a fiber optic physical layer simulator is apparent as the single mode fiber characteristics of attenuation, chromatic dispersion (CD), Non-Linear effects, such as Amplified Spontaneous Emissions (ASE) and Four Wave Mixing (FWM) and polarization mode dispersion (PMD) cause issues in optical networks. These effects are now impacting the deployment of high bitrate optical systems, such as those that offer data rates of 10 GB/sec and above. This is especially a significant issue for WDM and DWDM optical systems currently being developed for the minimum attenuation C band with a 1550 nm center wavelength. DWDM systems offer the possibility of high data rates in the hundreds of Terabits/sec by using the inherent wide bandwidth and optical wavelength division techniques now available.

As the demand for capacity grows, due to an increase in Internet traffic coupled with the high cost of installing new fiber, DWDM techniques currently being developed are for use for propagating and receiving optical signals on this previously deployed “dark” fiber, at the C band. This requires new compensation techniques to be developed for transmitting and receiving of optical signals using this existing fiber. Newer fibers being deployed have improved performance, over the previously installed optical fiber, in selected areas, however the effects still adversely affect the performance of the optical network. For WDM and DWDM systems, each wavelength typically requires unique CD and PMD tuning, or compensation, at high bit rates and for various optical fiber lengths. Additionally, several types of fibers are typically used in a real world fiber optic link, each having different characteristics which reduce one adverse physical parameter at the expense of some other. Additionally Non-Linear effects such as ASE, arising from the use of EDFAs and Four Wave Mixing effects, have significant effects on optical systems that propagate multiple wavelengths.

Due to the high cost of using tremendous lengths of any of the various types of optical fibers in testing systems, a need exists to be able to simulate different fiber types in a single test system, as well as being able to independently control Attenuation, CD and PMD for each simulated fiber length. This allows for the development of the next generation OC-192 and OC-768 optical networks over existing deployed single mode fiber as well as newly developed and deployed fiber. WDM and DWDM optical system developers appreciate the ability to “tune” or compensate their systems to match the fiber link, often at specific wavelengths for CD. In the past this has been manually adjusted in the field for hardwired optical links. For next generation networks, dynamic CD and PMD compensation is required. This requires optical system designers to be able to adjust CD and PMD independently and dynamically as the network topology changes. However, in order to be able to build fiber optic devices that are adjustable for CD and PMD, optical testing thereof is required in an environment the as closely as possible emulates actual optical links in the optical networks.

Typically, optical networks are simulated using very long spools of optical fiber, with lengths in the hundreds of kilometers. Unfortunately, these spools are very difficult to handle and often do not provide for a sufficient emulation of an actual optical link in the optical network.

It would be beneficial to provide a simple apparatus that conveniently simulates a fiber optic link, such as that found in an optical network. Further it would be beneficial if such a device were highly configurable to simulate a wide variety of fiber types and fiber lengths. It is therefore an object of the invention to provide an optical testing apparatus for simulating of various fiber types and for simulating various optical characteristics that are typically associated therewith.

### SUMMARY OF THE INVENTION

In accordance with the invention there is provided a test apparatus for receiving of an optical input signal at one of a plurality of different wavelengths comprising: a variable optical attenuator for providing optical attenuation to an optical signal propagating from an input port to an output port thereof in response to a first control signal; a first variable chromatic dispersion device for imparting a positive dispersion on an optical signal propagating from an input port to an output port thereof in response to a second control signal; a second variable chromatic dispersion device for imparting a negative dispersion on an optical signal propagating from an input port to an output port thereof in response to a third control signal; a jumper for coupling at least one of the output ports to at least one of the input ports; and, a microcontroller having an input port for receiving an external control signal and for providing the first, second and third control signals in dependence thereon in order to control all three devices in a coordinated fashion, where the test apparatus supports at least a first wavelength within a first optical channel and a second wavelength within a second optical channel.

In accordance with the invention there is provided a test apparatus for imparting an optical impairment on a first optical signal, comprising: an optical input port for receiving the first optical input signal; an optical output port for providing an optical output signal corresponding to the first optical signal additionally comprising the optical impairment; an optical path formed between the optical input port and the optical output port; a variable optical attenuator disposed in the optical path for providing optical attenuation to an optical signal propagating therethrough in response to a first control signal; a first variable chromatic dispersion device disposed in the optical path for imparting a positive dispersion on an optical signal propagating therethrough in response to a second control signal; a second variable chromatic dispersion device disposed in the optical path for imparting a negative dispersion on an optical signal propagating therethrough in response to a third control signal; and, a microcontroller having an input port for receiving an external control signal and for providing the first, second and third control signals in dependence thereon.

In accordance with the invention there is provided a method of creating an impairment in an optical signal using an electronic control device, comprising: adjusting an optical attenuation of the optical signal; adjusting a positive chromatic dispersion of the optical signal; adjusting a negative chromatic dispersion of the optical signal; and, providing the optical signal with the impairment comprising the optical attenuation, the positive chromatic dispersion and the negative chromatic dispersion, the optical impairments controlled by the electronic control device.

In accordance with the invention there is provided a method of optically simulating an optical network link, comprising: propagating of an optical signal along an optical path; providing a plurality of sets of first, second and third data; receiving of an input signal for selecting one of a plurality of sets of first, second and third data; generating a first control signal in dependence upon the first set of data; attenuating of the optical signal propagating along the optical path in dependence upon the first control signal; generating a second control signal in dependence upon the second set of data; varying a first chromatic dispersion of the optical signal propagating along the optical path in dependence upon the second control signal; generating a third control signal in dependence upon the third set of data; and, varying a second chromatic dispersion of the optical signal propagating along the optical path in dependence upon the third control signal.

### BRIEF DESCRIPTION OF THE DRAWINGS

Exemplary embodiments of the invention will now be described in conjunction with the following drawings, in which:

FIG. 1 illustrates an optical fiber simulator (OFS) according to a first embodiment of the invention;

FIG. 2 illustrates support for a plurality of different single-mode fiber types within limits of attenuation and chromatic dispersion for a selected channel for the OFS;

FIG. 3 illustrates the OFS for use in a laboratory computer controlled optical physical layer impairment simulator for use in testing of enterprise and metro optical network and C band optical systems;

FIG. 4 illustrates an OFS in accordance with a second embodiment of the invention, where the OFS in accordance with the second embodiment offers the introduction of an optical polarization impairment into an optical signal propagating through the OFS; and,

FIG. 5 illustrates operating steps for the OFS in accordance with the embodiments of the invention.

### DETAILED DESCRIPTION OF THE EMBODIMENTS OF THE INVENTION

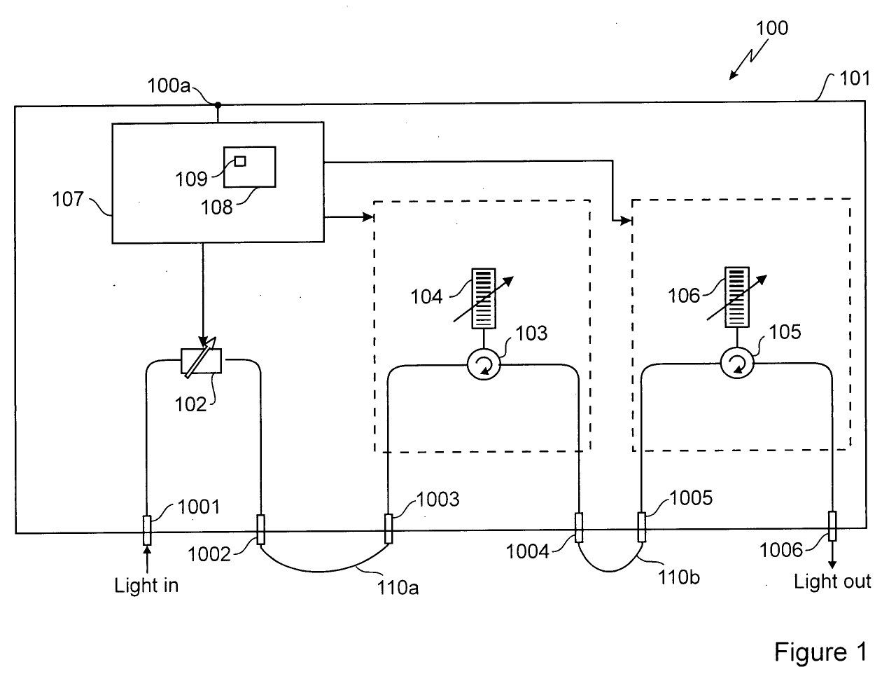

FIG. 1 illustrates an optical fiber simulator (OFS) 100 according to a first embodiment of the invention. The OFS is comprised of a housing 101 having first through sixth optical ports 1001 through 1006. A first variable optical attenuator (VOA) 102 is disposed between the first and second optical ports, 1001 and 1002. A first optical circulator (OC) 103 has its first port connected to the third optical port 1003 and its third port connected to the fourth optical port. A second port of the first optical circulator 103 is connected to a first tuneable dispersion compensator (TDC) 104. Connected to the fifth optical port 1005 is a first port of a second OC 105, with a third port thereof connected to the sixth optical port 1006. A second port of the second OC 105 is connected to a second TDC 106. The third optical port 1003, the first circulator 103, the first TDC 104 and the fourth optical port form a first variable chromatic dispersion device. The fifth optical port 1005, the second circulator 105, the second TDC 106 and the sixth optical port 1006 form a second variable chromatic dispersion device.

An electronic control device, in the form of a microcontroller 107 is disposed within the housing 101 in order to provide a first control signal to a control port of the first VOA 102, a second control signal to a control port of the first variable chromatic dispersion device 104, and to provide a third control signal to a control port of the second variable chromatic dispersion device. An external control signal for controlling of the microcontroller 107 is provided through an OFS control port 100a. A memory circuit 108 is provided as part of the microcontroller 107 for storing a plurality of sets of first, second, and third data that encodes for first, second, and third control signals in relation to the external control signal. Preferably a lookup table (LUT) 109 is stored within the memory circuit 108 for storing the various combinations of a formed within that is used to store the various combinations of first, second, and third data in relation to the OFS control signal.

In use, the OFS 100 is used for creating an optical impairment associated with a single optical channel from a plurality of supported optical channels in an optical communications network. The optical channel is selectable through the OFS control port 100a. An optical input signal is provided to the optical port 1001 and low loss optical jumpers 110a and 110b couple ports 1002 to 1003 and 1004 to 1005, respectively. An optical output signal having the optical impairment created thereon is provided from optical port 1006. Utilizing two jumpers and providing the optical input signal to port 1001 and receiving the output signal with the optical impairment created thereon is the preferably mode of operation of the OPS 100. Of course, other optical configurations of the OFS 100 are also possible.

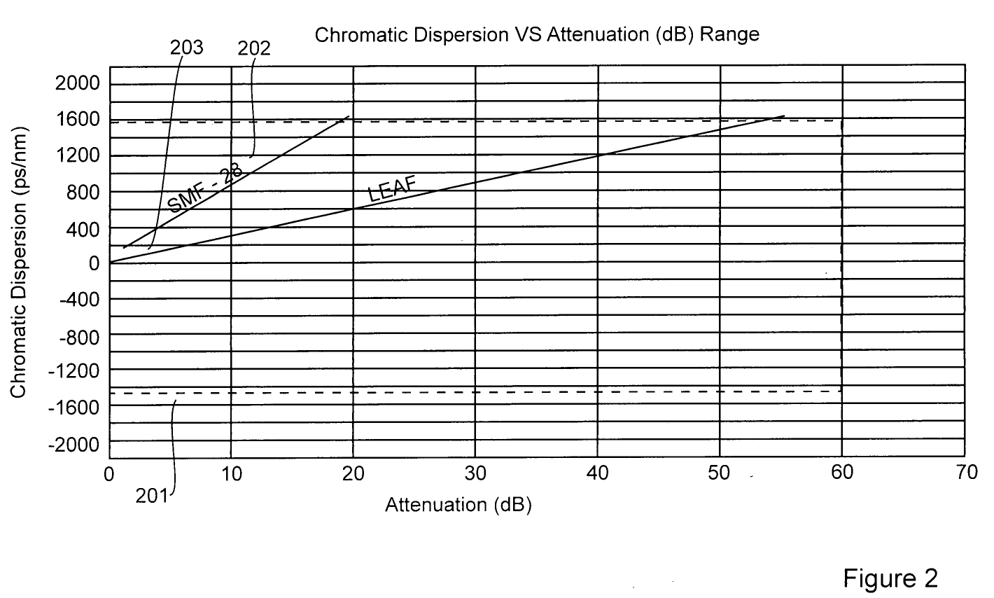

In order to select between the different supported types of optical fibers, the memory circuit 108 and LUT 109 are used for storing data representative of optical properties of chromatic dispersion and attenuation that are associated with each of the supported types of optical fibers. Referring to FIG. 2, the OFS 100 is used to support a plurality of different SMF types, 202 and 203, within the limits 201 of the attenuation and chromatic dispersion ranges for a selected channel. The OFS 100 provides for optical attenuations up to 60 dB with a CD of approximately −1500 ps/nm to +1500 ps/nm.

The OFS 100 in the first embodiment of the invention provides several modes of operation. It provides for optical fiber distance (km), optical fiber attenuation (dB) and adjustment of Chromatic Dispersion (CD) (ps/nm). For example, the LUT 109 has a provision for storing of first, second and third data for emulating G.652 type fibers, SMF-28, SMF-28e, ALLWave®, G.655 type fibers, LEAF®, MetroCor®, TrueWave® RS. Of course, support for any type of SMF fiber is possible within the limits of the attenuation and chromatic dispersion ranges for a selected channel. Up to 60 dB of wideband optical attenuation and chromatic dispersion of at least −1500 ps/nm to +1500 ps/nm range per selected channel allows for SMF-28, or G.652 standard, fiber spans of over 95 km to be supported. Preferably CD is adjustable in three ranges, −1000 ps/nm to +1000 ps/nm, −1500 ps/nm to −500 ps/nm and from +500 ps/nm to +1500 ps/nm.

The OFS 100 allows for user control of optical attenuation and of CD for a selected optical channel over wide dispersion and attenuation ranges. Attenuation and CD are combined into a single optical path to optically simulate individual ITU channel characteristics for different fibers like SMF-28 or LEAF®. Additionally, by adding additional optical components between ports 1002 and 1003, and 1004 and 1005, splices and other optical impairments are optionally simulated.

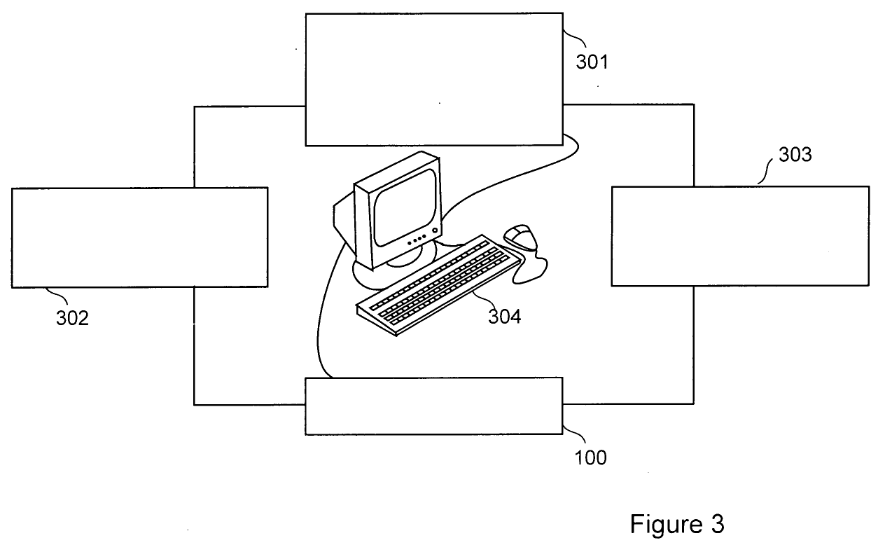

FIG. 3 illustrates the OFS 100 for use in a laboratory computer controlled optical physical layer impairment simulator for use in testing of enterprise and metro optical network and C band optical systems. As shown in FIG. 3, an optical data traffic and analysis system 301 is optically coupled to an optical device under test 302, which is further optically coupled to port 1001 of the OFS 100. Port 1006 of the OFS 100 is optically connected to an optical switch 303, which is optically coupled back to the optical data traffic and analysis system 301. A computer 304 is used to control the optical data traffic and analysis system 301, optical switch 303 and the OFS 100.

The OFS 100 advantageously reduces testing time and replaces reels of spliced fiber in the optical path. The OFS 100 is used for emulating long haul fiber links up to 100 km between EDFA's and provides an inexpensive alternative to actual optical network field testing. Through the OFS control port 100a, the computer 304 provides data signals to the VOA 102 and TDC 104 in order to simulate different fiber types, and allows for individual control, or in combination, attenuation and chromatic dispersion. Furthermore, it allows for emulating selected ITU channel dispersion and attenuation characteristics. Software selection by either one of ITU channel and center wavelength allows for optical channel by optical channel dispersion testing in CWDM and DWDM C band systems. The channel spacing is either 50 GHz or 100 GHz, in dependence upon user requirements. Of course, other exemplary wavelength channel spacings of 12.5 GHz, 25 GHz, and 200 GHz are also attainable.

Advantageously, the OFS 100 provides precise control over optical attenuation and chromatic dispersion. The OFS 100 chassis is rack mountable and is provide with front mounted optical connectors that function as the six optical ports, 1001 to 1006. The microcontroller 107 utilizes its internal processor for controlling the OFSs optical characteristics. The microcontroller 107 is connected to each of the optical components, 102, 104 and 106, using a thermally and mechanically isolated path in order to not interfere with the optical signals propagating between the optical components. Optionally, several OFSs are connected together to facilitate increased channel density or wider band testing. Advantageously, the OFS 100 is for operating at any one of a plurality of optical channels in telecommunication bands that are known to those of skill in the art. Exemplary telecommunication bands are O, E, S, C, and L bands.

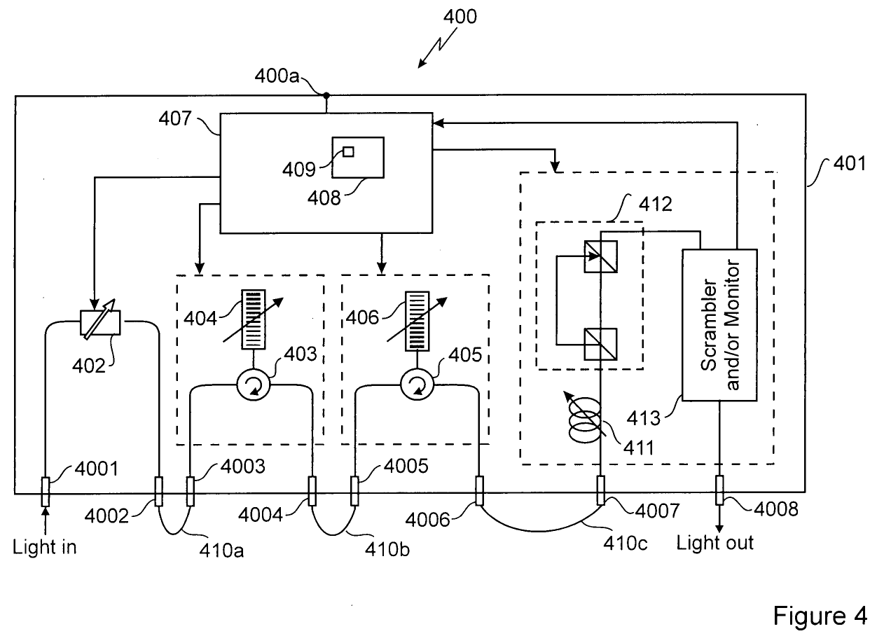

FIG. 4 illustrates an OFS 400 in accordance with a second embodiment of the invention. The OFS 400 offers similar functionality to that of the OFS 100, however it is also supports the introduction of an optical polarization impairment in addition to attenuation and CD. The OFS 400 is comprised of a housing 401 having first through eighth optical ports 4001 through 4008. A first variable optical attenuator (VOA) 402 is optically disposed between the first and second optical ports, 4001 and 4002. A first optical circulator (OC) 403 has its first port coupled to the third optical port 4003 and its third port coupled to the fourth optical port 4004. A second port of the first optical circulator 403 is coupled to a first tuneable dispersion compensator (TDC) 404. Coupled to the fifth optical port 4005 is a first port of a second OC 405, with a third port thereof coupled to the sixth optical port 4006. A second port of the second OC 405 is coupled to a second TDC 406. An input port of a polarization controller 411 is coupled to the seventh optical port 4007 and an optical output port thereof is coupled to an input port of a variable optical delay component 412. An output port of the variable optical delay component is coupled to at least one of a polarization scrambler and polarization monitor 413. An output port of the at least one of a polarization scrambler and polarization monitor 413 is coupled to the eighth optical port 4008. Of course, optionally multiple polarization mode dispersion optical devices are also coupled in series with the polarization mode dispersion optical device in order to simulate high order polarization effects.

The third optical port 4003, the first circulator 403, the first TDC 404 and the fourth optical port form a first variable chromatic dispersion device. The fifth optical port 4005, the second circulator 405, the second TDC 406 and the sixth optical port 4006 form a second variable chromatic dispersion device. The seventh optical port 4007, polarization controller 411, optical delay line 412, the at least one of a polarization scrambler and polarization monitor 413 and eighth optical port 4008 form a polarization mode dispersion optical device for imparting a polarization mode dispersion optical impairment on an optical signal propagating from ports 4007 to 4008.

An electronic control device, in the form of a microcontroller 407 is disposed within the housing 401 in order to provide a first control signal to a control port of the first VOA 402, a second control signal to a control port of the first variable chromatic dispersion device, and to provide a third control signal to a control port of the second variable chromatic dispersion device. A fourth control signal is provided to the polarization mode dispersion optical device for controlling of the polarization controller 411, the variable optical delay component 411 and the at least one of a polarization scrambler and polarization monitor 412. The polarization monitor optionally provides a feedback signal to the microcontroller 407 in order to provide feedback relating to the change in the optical polarization of light realized by the polarization controller 411.

An external control signal for controlling of the microcontroller 407 is provided through an OFS control port 400a. A memory circuit 408 is provided as part of the microcontroller 407 for storing various combinations of first, second, third and fourth data that encodes for the first, second, third and fourth control signals in relation to the external control signal. Preferably a lookup table (LUT) 409 is implemented within the memory circuit 408 for storing the various data coding for the first, second, third and fourth control signals in relation to the external control signal.

In use, the OFS 400 is used for creating an optical impairment for a single optical channel from a plurality of optical channels for simulating of an optical communications network. Of course, the polarization mode dispersion optical device—disposed between ports 4007 and 4008 is a broadband optical device that affects all WDM channels propagating therethrough simultaneously. The single optical channel is selected using the OFS control port 400a. An optical input signal is provided to the optical port 4001 and low loss optical jumpers 410a through and 410c connect ports 4002 and 4003, 4004 and 4005, and 4006 and 4007, respectively. An optical output signal having the optical impairment created thereon is provided from optical port 4008. Utilizing three jumpers and providing the optical input signal to port 4001 and receiving the output signal from port 4008 is the preferable mode of operation for the OPS 400. Of course, other optical configurations of the OFS 400 are also possible, where additional optical devices are inserted between optical ports 4002 and 4003, 4004 and 4005, and 4006 and 4007.

The OFS 400 is utilized in a similar manner to the OFS 100. Computer control of the OFS 400 provides for an automated testing system that is capable of testing of a plurality of optical channels, such as the testing system illustrated in FIG. 3. Of course, because the OFS 400 includes polarization varying components, a more accurate representation of an actual optical link of an optical network is attained. With the means for varying the optical attenuation, positive and negative CD, as well as polarization varying capabilities, the OFS 400 advantageously offers a more accurate representation of an actual fiber optic link.

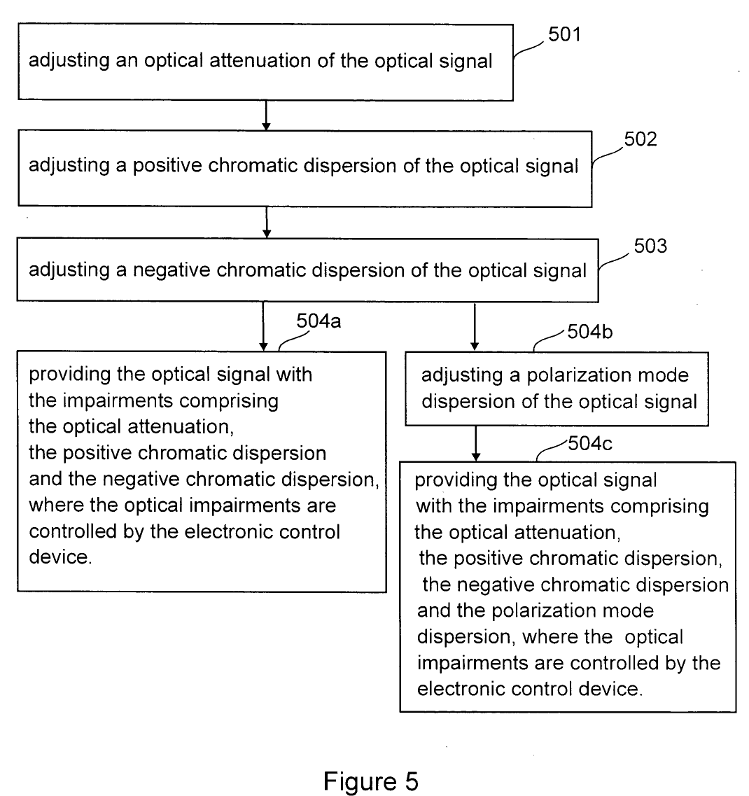

FIG. 5 illustrates the operating steps for the OFS 100 and the OFS 400 for an optical signal propagating therethrough. Referring to step 501, adjusting an optical attenuation of the optical signal is performed. In step 502, a positive chromatic dispersion of the optical signal is adjusted. Adjusting a negative chromatic dispersion of the optical signal is performed in step 503. Referring to the OFS 100, in step 504a, providing the optical signal with the impairments comprising the optical attenuation, the positive chromatic dispersion and the negative chromatic dispersion, where the electronic control device 107 controls the optical impairments. Referring to the OFS 400, in step 504b adjusting a polarization mode dispersion of the optical signal is performed. Thereafter in step 504c, providing the optical signal with the impairments comprising the optical attenuation, the positive chromatic dispersion, the negative chromatic dispersion and the polarization mode dispersion, where the electronic control device 407 controls the optical impairments.

The embodiments of the invention advantageously allow for dramatic time and cost savings to be realized in automated testing of optical components or of an optical system test environment. Through interfacing with the OFS, 100 and 400, via the OFS control port, 100a and 400a, automated testing scripts in execution on a computer 304 (FIG. 3) reduce optical device testing costs in optical device production testing.

The use of external jumpers in conjunction with the embodiments of the invention is to enhance the flexibility of the embodiments of the invention. It will be apparent to those of skill in the art of optical design that the various optical components are optionally optically coupled together in, for example, a fixed manner by splicing their optical fibers together to form configurations optically equivalent to either of the first and second embodiments of the invention.

Numerous other embodiments may be envisaged without departing from the spirit or scope of the invention.

1. A test apparatus for receiving of an optical input signal at one of a plurality of different wavelengths comprising:
a variable optical attenuator for providing optical attenuation to an optical signal propagating from an input port to an output port thereof in response to a first control signal;
a first variable chromatic dispersion device for imparting a positive dispersion on an optical signal propagating from an input port to an output port thereof in response to a second control signal;
a second variable chromatic dispersion device for imparting a negative dispersion on an optical signal propagating from an input port to an output port thereof in response to a third control signal;
a jumper for coupling at least one of the output ports to at least one of the input ports; and,
a microcontroller having an input port for receiving an external control signal and for providing the first, second and third control signals in dependence thereon in order to control all three devices in a coordinated fashion,
where the test apparatus supports at least a first wavelength within a first optical channel and a second wavelength within a second optical channel.

2. A test apparatus according to claim 1, wherein the microcontroller comprises a lookup table (LUT) for storing a plurality of sets of first, second and third data from which the first, second and third control signals are derived.

3. A test apparatus according to claim 2, wherein the external control signal is used to index the plurality of sets of first, second and third data.

4. A test apparatus according to claim 1, comprising a polarization mode dispersion optical device for imparting polarization mode dispersion on an optical signal propagating from an input port to an output port thereof in response to a fourth control signal.

5. A test apparatus according to claim 4, wherein the polarization mode dispersion optical device comprises:
a polarization mode controller;
an optical delay line; and,
at least one of a polarization scrambler and polarization monitor disposed along an optical path between the input port and the output ports of the polarization mode dispersion optical device.

6. A test apparatus according to claim 1, wherein the first variable chromatic dispersion device is for imparting a positive dispersion of up to +1500 ps/nm and the second variable chromatic dispersion device is for imparting a negative dispersion of up to −1500 ps/nm.

7. A test apparatus according to claim 1, wherein the first variable chromatic dispersion device comprises:
a first tunable dispersion compensator;
a first optical circulator having a first port optically coupled to the first port of the first variable chromatic dispersion device, a third port optically coupled to the second port of the first variable chromatic dispersion device and a second port optically coupled to the first tunable dispersion compensator.

8. A test apparatus according to claim 1, wherein the first variable chromatic dispersion device comprises:
a second tunable dispersion compensator;
a second optical circulator having a first port optically coupled to the first port of the second variable chromatic dispersion device, a third port optically coupled to the second port of the second variable chromatic dispersion device and a second port optically coupled to the second tunable dispersion compensator.

9. A test apparatus for imparting an optical impairment on a first optical signal, comprising:
an optical input port for receiving the first optical input signal;
an optical output port for providing an optical output signal corresponding to the first optical signal additionally comprising the optical impairment;
an optical path formed between the optical input port and the optical output port;
a variable optical attenuator disposed in the optical path for providing optical attenuation to an optical signal propagating therethrough in response to a first control signal;
a first variable chromatic dispersion device disposed in the optical path for imparting a positive dispersion on an optical signal propagating therethrough in response to a second control signal;
a second variable chromatic dispersion device disposed in the optical path for imparting a negative dispersion on an optical signal propagating therethrough in response to a third control signal; and,
a microcontroller having an input port for receiving an external control signal and for providing the first, second and third control signals in dependence thereon.

10. A test apparatus according to claim 9, wherein the microcontroller comprises a lookup table (LUT) for storing a plurality of sets of first, second and third data from which the first, second and third control signals are derived.

11. A test apparatus according to claim 10, wherein the external control signal is used to index the plurality of sets of first, second and third data.

12. A test apparatus according to claim 9, comprising a polarization mode dispersion optical device disposed in the optical path for imparting polarization mode dispersion on an optical signal propagating from an input port to an output port thereof in response to a fourth control signal.

13. A method of creating an impairment in an optical signal using an electronic control device, comprising:
adjusting an optical attenuation of the optical signal;
adjusting a positive chromatic dispersion of the optical signal;
adjusting a negative chromatic dispersion of the optical signal; and,
providing the optical signal with the impairment comprising the optical attenuation, the positive chromatic dispersion and the negative chromatic dispersion, the optical impairments controlled by the electronic control device.

14. A method according to claim 13, comprising adjusting a polarization mode dispersion of the optical signal, wherein the impairment comprises the polarization mode dispersion.

15. A method of optically simulating an optical network link, comprising:
propagating of an optical signal along an optical path;
providing a plurality of sets of first, second and third data;
receiving of an input signal for selecting one of a plurality of sets of first, second and third data;
generating a first control signal in dependence upon the first set of data;
attenuating of the optical signal propagating along the optical path in dependence upon the first control signal;
generating a second control signal in dependence upon the second set of data;
varying a first chromatic dispersion of the optical signal propagating along the optical path in dependence upon the second control signal;
generating a third control signal in dependence upon the third set of data; and, varying a second chromatic dispersion of the optical signal propagating along the optical path in dependence upon the third control signal.

16. A method according to claim 15, comprising:
selecting a different one of a plurality of first, second and third data sets; and,
varying at least one of an attenuation, a first chromatic dispersion and a second chromatic dispersion in dependence upon the different one of a plurality of first, second and third data sets.

17. A method according to claim 15, wherein the plurality of sets of first, second and third data comprises fourth data;
generating a fourth control signal in dependence upon the fourth data; and
varying a polarization mode dispersion of the optical signal propagating along the optical path in dependence upon the fourth control signal.

18. A method according to claim 17, wherein optical characteristic of the optical network link are represented by one of the plurality of sets of first, second, third and fourth data.
